(19) United States
(12) Patent Application Publication
(10) Pub. No.: US 2024/0403002 A1
(43) Pub. Date: Dec. 5, 2024

(54) CODE ANNOTATION AND TEST COVERAGE VISUALIZATION ON USER INTERFACE BY LEVERAGING PAGE OBJECT DESIGN PATTERN

(71) Applicant: International Business Machines Corporation, Armonk, NY (US)

(72) Inventors: Jin Shi, Ningbo (CN); Chao Yuan Huang, Taipei (TW); Chun-Sheng Chung, Taipei (TW); Fan Yang, Beijing (CN); Rong Chen, Ningbo (CN)

(21) Appl. No.: 18/205,943

(22) Filed: Jun. 5, 2023

(51) Int. Cl. G06F 8/34; G06F 11/36

(52) U.S. Cl. CPC G06F 8/34; G06F 11/3688

(57) ABSTRACT

In one general embodiment, a computer-implemented method includes analyzing document object model code for generating locators of elements of a web page. The locators are output visibly on a user interface displaying the web page. A page object code template of the web page is generated. Mappings of the elements and/or the locators to page object variables are received from a user. Representations of the mappings are output visibly on the user interface displaying the web page. Mappings from page areas of the web page to page object functions are received from the user. Representations of the mappings from the page areas of the web page to the page object functions are output visibly on the user interface displaying the web page. Code references are rendered on the user interface displaying the web page.

### BACKGROUND

The present invention relates to user interface (UI) automation testing and more specifically, this invention relates to generating visualization of test coverage on a user interface by leveraging a page object design pattern.

In order to save costs, usually, in a translation verification test, the testers are not fixed. Rather, the testers vary for different projects in the resource pool, which is often referred to as a shared service model. However, in this model, while saving labor costs, it also creates new problems. One of the more prevalent problems involves the transition of automated scripts.

The cost of maintaining code documentation and comments is high, and the integrity and quality are difficult to guarantee. Over time, automation scripts often lead to duplication of work during transition.

### SUMMARY

A computer-implemented method, in accordance with one embodiment, includes analyzing document object model code for generating locators of elements of a web page. The locators are output visibly on a user interface displaying the web page. A page object code template of the web page is generated. Mappings of the elements and/or the locators to page object variables are received from a user. Representations of the mappings are output visibly on the user interface displaying the web page. Mappings from page areas of the web page to page object functions are received from the user. Representations of the mappings from the page areas of the web page to the page object functions are output visibly on the user interface displaying the web page. Code references are rendered on the user interface displaying the web page.

A computer program product, in accordance with one embodiment, includes a computer readable storage medium having program instructions embodied therewith. The program instructions are executable by a computer to cause the computer to perform the foregoing method.

A system, in accordance with one embodiment, includes processor, and logic integrated with the processor, executable by the processor, or integrated with and executable by the processor. The logic is configured to perform the foregoing methodology.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a flowchart of a method, in accordance with one embodiment of the present invention.

FIG. 3 is a flowchart of a method, in accordance with one embodiment of the present invention.

FIG. 4 is a depiction of a mapping, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for generating visualization of test coverage on a UI by leveraging a page object design pattern. When used for UI automation testing in different languages, the change effort is reduced for automation script when execution translation verification testing.

In one general embodiment, a computer-implemented method includes analyzing document object model code for generating locators of elements of a web page. The locators are output visibly on a user interface displaying the web page. A page object code template of the web page is generated. Mappings of the elements and/or the locators to page object variables are received from a user. Representations of the mappings are output visibly on the user interface displaying the web page. Mappings from page areas of the web page to page object functions are received from the user. Representations of the mappings from the page areas of the web page to the page object functions are output visibly on the user interface displaying the web page. Code references are rendered on the user interface displaying the web page.

In another general embodiment, a computer program product includes a computer readable storage medium having program instructions embodied therewith. The program instructions are executable by a computer to cause the computer to perform the foregoing method.

In another general embodiment, a system includes processor, and logic integrated with the processor, executable by the processor, or integrated with and executable by the processor. The logic is configured to perform the foregoing methodology.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code for generating visualization of test coverage on a user interface by leveraging a page object design pattern in block 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

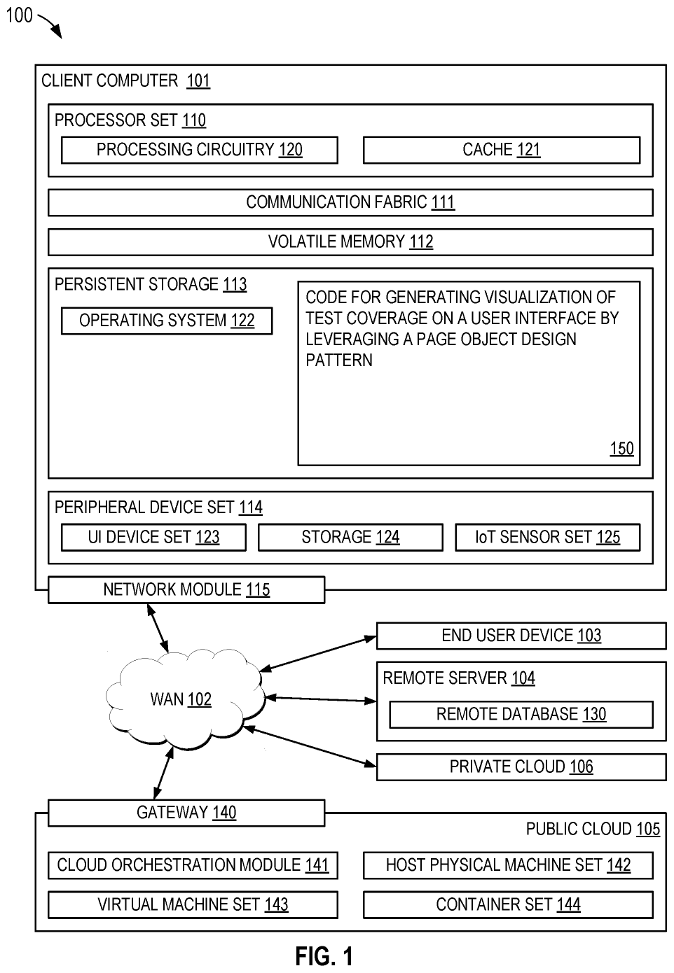

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

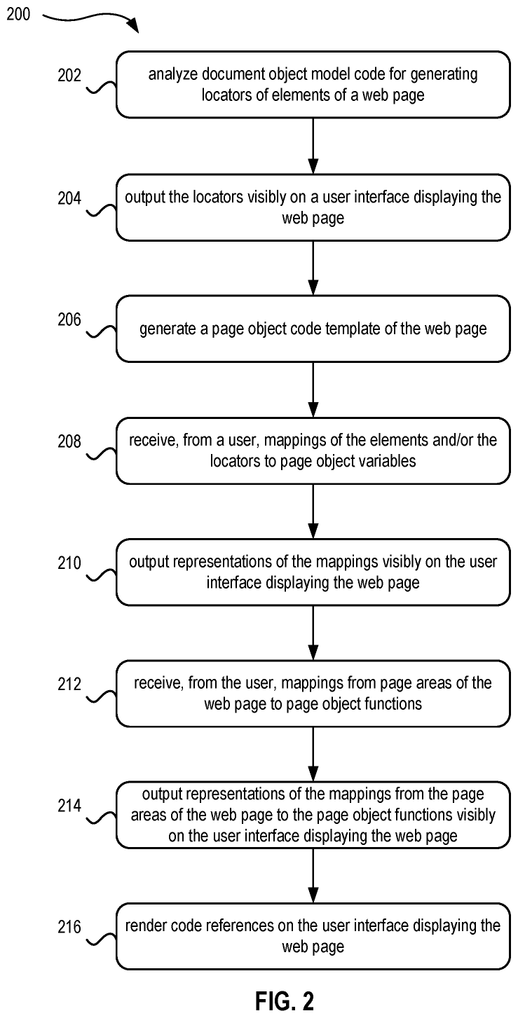

Now referring to FIG. 2, a flowchart of a method 200 is shown according to one embodiment. The method 200 may be performed in accordance with the present invention in any of the environments depicted in FIG. 1, among others, in various embodiments. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various embodiments, the method 200 may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 2, method 200 may initiate with operation 202, where document object model (DOM) code is analyzed for generating locators of the elements (e.g., web elements) of a web page. The DOM code and locators may be generated, preferably automatically in response to invoking the method 200, via known techniques.

In operation 204, the locators are output visibly on a user interface displaying at least a portion of the web page. Preferably, the locators are positioned on or near the elements to which they pertain. The locators may take any visual form desired, such as a link to additional information, an icon, text, etc.

While in a preferred embodiment the computer performing the method identifies each web element on the web page and generates the locators of each web element visibly on the user interface, the elements of the web page that are identified are preferably functional elements, e.g., buttons, fields, etc.

In operation 206, a page object code template of the web page object is generated. This operation may be performed by creating and/or analyzing page object model (POM) code in a known manner. The POM encapsulate the properties and the behavior of the corresponding web page. The POM may be a layer between the test automation code and the user interface. In one embodiment, generating the page object code template of the web page includes analyzing POM code of a web page object that includes the web page or portion thereof.

In preferred aspects, a page object may be defined as an object-oriented class that serves as an interface to a page of the automation testing. The test then uses the methods of this page object class whenever it needs to interact with the UI of that page. One benefit of using page objects is that if the UI changes for the page, the tests themselves do not to change, only the code within the page object needs to change. Subsequently, all changes to support that new UI are located in one place.

In one embodiment, generating the page object code template of the web page includes defining a class for a particular function enabled by a particular set of the elements. A representation of the class and variables corresponding thereto is output.

The page object code template may be generated for allowing users to invoke a method on the page which is the class of page object.

In operation 208, mappings of the elements and/or the locators to page object variables in the code are received from a user. The user may create the mappings via any technique that would become apparent to those skilled in the art after reading the present disclosure. For example, the user may type in the correlations between the two items to be mapped, may drag and drop the items via a graphical user interface, etc.

With understanding of the relationship between each object on the same web page, the methodology allows users to map web elements to page object variables, and therefore, the page object class with variable is initiated.

In operation 210, representations of the mappings are output visibly on the user interface displaying the web page. The representations may be output in any desired manner. For example, a table of the mappings may be presented overlaying the web page, in a separate window, etc.

At some point before or during the method 200, the user, e.g., a test developer, may create and/or finish the automation test code for the specific elements. Moreover, test scripts may be received for at least some of the elements; The test scripts may be written by the user.

After the test developer writes the business and test logic based on the page object template, the mapping between the element group (e.g., page range) on the page and the logic method in the code is generated according to the invoke on the object variables in the business logic.

In operation 212, mappings from page areas of the web page to page object functions are received from the user. The user may create the mappings via any technique that would become apparent to those skilled in the art after reading the present disclosure. For example, the user may type in the correlations between the two items to be mapped, may drag and drop the items via a graphical user interface, etc.

In one approach, based on analyzing the invocation of the page object variable in the business logic, the mapping from the element groups/page area to the business logic is generated, e.g., by the user, by the computer performing the method 200, etc.

In one approach, the mappings from page areas of the web page to page object functions include a mapping from one of the page areas to the class.

The method 200 may include receiving business logic for at least some of the elements of the web page, receiving test logic for testing the business logic, invoking the test logic, mapping object variables invoked by the test logic to one of the page areas, and outputting a representation of the page area on the user interface displaying the web page.

In operation 214, representations of the mappings from the page areas of the web page to the page object functions are output visibly on the user interface displaying the web page.

In operation 216, code references, such as variables and functional names, are rendered visibly on the user interface displaying the web page. Preferably, the abstraction and coverage of the code to the page are directly presented in the web page, which not only intuitively increases the understanding of the code, but also shows the test coverage of the web page.

In a preferred approach, the code reference (e.g., mapping between page elements and page object variables and the mapping between element group/page area and page object methods) is output on the user interface displaying the web page.

In a preferred embodiment, the above-mentioned artifacts are generated and visible on the user interface. Through the understanding of business logic, a user, such as an automation developer, may finalize the page object class with the method. Because the finalized page object class is visible on the user interface, such embodiment allows a user to map the page object class to the corresponding page area. Because the finalized page object class is visible on user interface, an automation developer can leverage the code on the user interface to complete testing for user interface functionality and know the test coverage for the exact page.

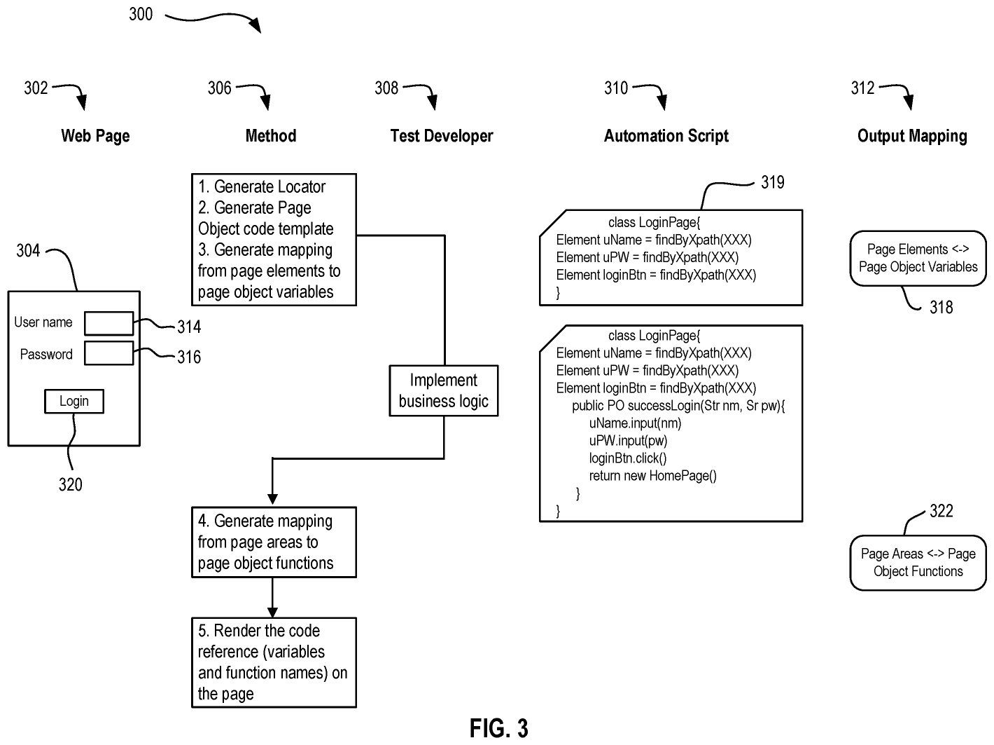

Now referring to FIG. 3, a flowchart of a method 300 performed on a login page is shown according to one embodiment. The method 300 may be performed in accordance with the present invention in any of the environments depicted in FIGS. 1-2, among others, in various embodiments. Of course, more or fewer operations than those specifically described in FIG. 3 may be included in method 300, as would be understood by one of skill in the art upon reading the present descriptions.

Each of the steps of the method 300 may be performed by any suitable component of the operating environment. For example, in various embodiments, the method 300 may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown, the information in FIG. 3 is presented via columns. In the first column 302 is a login page 304. In the second column 306 are the steps performed in this illustrative method. In the third column 308, actions by a user (test developer) are listed. In the fourth column 310, exemplary automation scripts at various stages of the method 300 are presented. The fifth column 312 includes exemplary output mappings that are displayed to the user on a user interface.

Referring to the second column 306, the initial steps of the exemplary method are performed. Particularly, in step 1., the locators of all web elements on the login page 304 are generated and made visible on the user interface that displays the login page 304. In step 2., using page object models (POM) technology, the login abstract method which is the class of login page objects is generated. Step 2. May also entail generating the testing method and test variables. The locators may be used such that the automation script knows how to run the test method with the correct location on the login page.

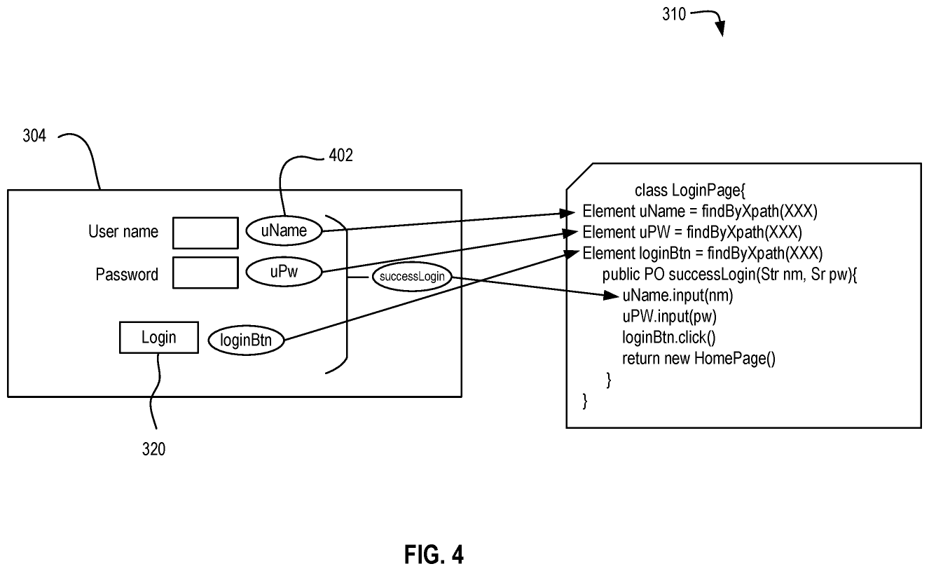

In step 3., the user is allowed to map the locator of web elements (e.g., user name and user password fields 314, 316) to the corresponding page object variables (e.g., the variable of user name and password in the class) visibly and therefore the page object class with the variables defined is initiated on the user interface. Thus, an output mapping 318 is created, as shown in the fifth column 312. FIG. 4 depicts an exemplary mapping of the web elements (e.g., via the locators 402 of the web elements) to the page object variables found in the automation script of the fourth column 310. The mapping may help the user generate the test code for the automation script. Note also, as shown in the fourth column 310, the page object model output 319 may list the object variable, the value of the object, and the logic corresponding to the object.

Referring to the third column 308, because the user (e.g., test developer) understands the business logic, the user may implement the page object class initiated on the above step of the method of the second column 306. In the example shown, the login function is invoked by the login button 320 of the login page 304 to finalize the page object class.

Referring to step 4. in the second column 306, the user is allowed to map the finalized page object class to the corresponding page area visibly, resulting in an output mapping 322 as shown in the fifth column 312. See step 5. FIG. 4 depicts an exemplary mapping. Note that step 4. may entail mapping several page object classes, e.g., across the entire web page, to the respective page area.

The user may directly leverage the class to test the login feature and understand the coverage of the test on the page.

The methodology presented in FIGS. 2-4 and peripheral description may provide some or all of the following advantages.

First, the methodology produces an effect of code annotation with original page context, which may benefit automation coding and translation.

Second, if portions of the methodology are combined with online or plug-in IDE, a connection between page object and code behind it may be created. Thus, the methodology may include receiving a selection of one of the objects on the user interface; and in response to receiving the selection, outputting a code block associated with the object. In one example, the user clicks the object linked to an integrated development environment (IDE) code block, resulting in opening of a window to the IDS code block.

Third, to a certain extent, the methodology may provide intuitive user interface test coverage visualization. A page object appearing without this kind of annotation indicated that it is not covered by the automation code (e.g., test code), thereby indicating that the tester should supplement the automation code in a targeted manner.

Fourth, missed business logic coverage can be easily identified via viewing the code reference on the page, and the missing logic can be easily implemented based on referring and invoking the pertinent page object variables (e.g., abstractions of the web elements on the page).

Fifth, some embodiments leverage page object processes to further map to automation scripts and visualize test coverage, which is superior to using artifact reports.

Finally, the foregoing methodology reduces UI automation script development and maintenance effort, and makes the automation test coverage clear at each release, as well as when a test project is transferred to another owner.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
analyzing document object model code for generating locators of elements of a web page;
outputting the locators visibly on a user interface displaying the web page;
generating a page object code template of the web page;
receiving, from a user, mappings of the elements and/or the locators to page object variables;
outputting representations of the mappings visibly on the user interface displaying the web page;
receiving, from the user, mappings from page areas of the web page to page object functions;
outputting representations of the mappings from the page areas of the web page to the page object functions visibly on the user interface displaying the web page; and
rendering code references on the user interface displaying the web page.

2. The computer-implemented method of claim 1, comprising receiving business logic for at least some of the elements of the web page; receiving test logic for testing the business logic; invoking the test logic; mapping object variables invoked by the test logic to one of the page areas; and outputting a representation of the page area on the user interface displaying the web page.

3. The computer-implemented method of claim 1, wherein generating the page object code template of the web page includes defining a class for a particular function enabled by a particular set of the elements, and comprising outputting a representation of the class and variables corresponding thereto.

4. The computer-implemented method of claim 3, wherein the mappings from page areas of the web page to page object functions include a mapping from one of the page areas to the class.

5. The computer-implemented method of claim 4, comprising receiving business logic for the elements of the web page in the class; receiving test logic for testing the business logic; invoking the test logic; mapping the object variables invoked by the test logic to one of the page areas; and outputting a representation of the page area on the user interface displaying the web page.

6. The computer-implemented method of claim 1, comprising receiving a selection of one of the objects on the user interface; and in response to receiving the selection, outputting a code block associated with the object.

7. The computer-implemented method of claim 1, wherein generating the page object code template of the web page includes analyzing page object model code of a web page object corresponding to the web page.

8. A computer program product, the computer program product comprising a computer readable storage medium having program instructions embodied therewith, the program instructions executable by a computer to cause the computer to:
analyze, by the computer, document object model code for generating locators of elements of a web page;
output, by the computer, the locators visibly on a user interface displaying the web page;
generate, by the computer, a page object code template of the web page;
receive, by the computer from a user, mappings of the elements and/or the locators to page object variables;
output, by the computer, representations of the mappings visibly on the user interface displaying the web page;
receive, by the computer from the user, mappings from page areas of the web page to page object functions;
output, by the computer, representations of the mappings from the page areas of the web page to the page object functions visibly on the user interface displaying the web page; and
render, by the computer, code references on the user interface displaying the web page.

9. The computer program product of claim 8, comprising program instructions executable by the computer to cause the computer to: receive business logic for at least some of the elements of the web page; receiving test logic for testing the business logic; invoke the test logic; map object variables invoked by the test logic to one of the page areas; and output a representation of the page area on the user interface displaying the web page.

10. The computer program product of claim 8, wherein generating the page object code template of the web page includes defining a class for a particular function enabled by a particular set of the elements, and comprising program instructions executable by the computer to cause the computer to output a representation of the class and variables corresponding thereto.

11. The computer program product of claim 10, wherein the mappings from page areas of the web page to page object functions include a mapping from one of the page areas to the class.

12. The computer program product of claim 11, comprising program instructions executable by the computer to cause the computer to: receive business logic for the elements of the web page in the class; receiving test logic for testing the business logic; invoke the test logic; map the object variables invoked by the test logic to one of the page areas; and output a representation of the page area on the user interface displaying the web page.

13. The computer program product of claim 8, comprising program instructions executable by the computer to cause the computer to receive a selection of one of the objects on the user interface, and in response to receiving the selection, output a code block associated with the object.

14. The computer program product of claim 8, wherein generating the page object code template of the web page includes analyzing page object model code of a web page object corresponding to the web page.

15. A system, comprising:
a processor; and
logic integrated with the processor, executable by the processor, or integrated with and executable by the processor, the logic being configured to:
analyze document object model code for generating locators of elements of a web page;
output the locators visibly on a user interface displaying the web page;
generate a page object code template of the web page;
receive, from a user, mappings of the elements and/or the locators to page object variables;
output representations of the mappings visibly on the user interface displaying the web page;
receive, from the user, mappings from page areas of the web page to page object functions;
output representations of the mappings from the page areas of the web page to the page object functions visibly on the user interface displaying the web page; and
render code references on the user interface displaying the web page.

16. The system of claim 15, comprising logic for: receiving business logic for at least some of the elements of the web page; receiving test logic for testing the business logic; invoking the test logic; mapping object variables invoked by the test logic to one of the page areas; and outputting a representation of the page area on the user interface displaying the web page.

17. The system of claim 15, wherein generating the page object code template of the web page includes defining a class for a particular function enabled by a particular set of the elements, and comprising outputting a representation of the class and variables corresponding thereto.

18. The system of claim 17, wherein the mappings from page areas of the web page to page object functions include a mapping from one of the page areas to the class.

19. The system of claim 18, comprising receiving business logic for the elements of the web page in the class; receiving test logic for testing the business logic; invoking the test logic; mapping the object variables invoked by the test logic to one of the page areas; and outputting a representation of the page area on the user interface displaying the web page.

20. The system of claim 15, comprising logic for receiving a selection of one of the objects on the user interface; and logic for outputting a code block associated with the object in response to receiving the selection.
